(19) United States
(12) Patent Application Publication
(10) Pub. No.: US 2001/0020880 A1
(43) Pub. Date: Sep. 13, 2001

(54) Stacked type dielectric resonator

(75) Inventors: Yasuhiko Muzutani, Komaki-City (JP); Takami Hirai, Nishikamo-Gun (JP); Kazuyuki Mizuno, Kasugai-City (JP); Takeshi Noguchi, Saku-City (JP)

Correspondence Address: BURR & BROWN, PO BOX 7068, SYRACUSE, NY, 13261-7068, US

(73) Assignee: NGK Insulators, Ltd.

(21) Appl. No.: 09/781,692

(22) Filed: Feb. 12, 2001

(30) Foreign Application Priority Data
Feb. 15, 2000 (JP) 2000-036450

(51) Int. Cl. H01P 7/08

(52) U.S. Cl. 333/219

(57) ABSTRACT

A stacked type dielectric resonator comprises a plurality of stripline conductors disposed in a dielectric substrate composed of a plurality of stacked dielectric layers, and a ground electrode formed on the dielectric substrate, wherein via holes are provided, which electrically connect the respective stripline conductors, for example, to portions of the ground electrode disposed on a lower surface respectively.

### BACKGROUND OF THE INVENTION

1. Field of the Invention

The present invention relates to a stacked type dielectric resonator which constitutes a resonance circuit in a microwave band in a range of several hundreds MHz to several GHz. In particular, the present invention relates to a stacked type dielectric resonator which has a compact size, which involves low loss, and which is usable, for example, for band-pass filters, duplexers, and oscillators.

2. Description of the Related Art

Recently, as the wireless communication system such as portable telephones is diversified, it is strongly demanded for the stacked type dielectric filter to realize a compact size and low loss.

In order to realize the low loss of the stacked type dielectric filter, it is necessary to improve the no-load Q of a stacked type dielectric resonator which constitutes the stacked type dielectric filter. The no-load Q of the resonance circuit is principally determined by the loss (dielectric loss) due to the dielectric of the dielectric substrate and the loss (conductor loss) due to the stripline conductor. In general, in a low frequency band which is equivalent to or lower than the microwave band, the conductor loss is dominant for the no-load Q as compared with the dielectric loss.

Therefore, in order to realize the low loss of the stacked type dielectric filter and improve the no-load Q, the following means are conceived.

(1) The specific resistance of the conductor material for forming the stripline conductor is decreased.

(2) The width and the thickness of the stripline conductor are increased.

However, the means (1), in which the specific resistance is decreased as described above, causes such a fear that any limit may arise concerning the material and the cost. The means (2), in which the size of the stripline conductor is increased, causes such a problem that an electronic part including the stacked type dielectric resonator may become large.

In view of the above, for example, the following means has been hitherto suggested. That is, a pair of ground electrodes are formed on upper and lower surfaces of a dielectric substrate. A stripline conductor is stacked in parallel to the ground electrodes between the pair of ground electrodes with dielectric layers intervening therebetween (see Japanese Laid-Open Patent Publication No. 4-43703).

However, in this case, a fear arises such that the adjustment for the resonance frequency may involve any difficulty, because the short-circuited end of the stripline conductor is exposed to only the upper and lower surfaces of the dielectric substrate.

### SUMMARY OF THE INVENTION

The present invention has been made taking the foregoing problems into consideration, an object of which is to provide a stacked type dielectric resonator which has a simple structure, which makes it possible to effectively reduce the conductor loss which would be otherwise caused by a stripline conductor, and which makes it possible to improve the no-load Q of the resonator.

Another object of the present invention is to provide a stacked type dielectric resonator which makes it possible to adjust the resonance frequency with ease, in addition to the requirement described above.

According to the present invention, there is provided a stacked type dielectric resonator comprising a dielectric substrate including a plurality of dielectric layers stacked and integrated into one unit; and a ground electrode and a stripline conductor stacked with each other with the dielectric layer interposed therebetween; wherein a first end of the stripline conductor is electrically connected to the ground electrode; and the stripline conductor is provided with an additional member for increasing a portion through which a high frequency current in a microwave band flows.

Accordingly, in the present invention, the portion, through which the high frequency current in the microwave band flows, is successfully increased by the aid of the additional member. Therefore, it is possible to effectively reduce, with the simple structure, the conductor loss which would be otherwise caused by the stripline conductor. Further, it is possible to improve the no-load Q of the resonator.

It is preferable that the additional member is composed of a via hole for electrically connecting the stripline conductor and the ground electrode. In this arrangement, it is preferable that the ground electrode is stacked with the dielectric layers intervening therebetween so that the stripline conductor is interposed therebetween; and the additional member is composed of via holes extending in both directions from the stripline conductor to portions of the ground electrode respectively. By doing so, the portion, through which the high frequency current in the microwave band flows, is further increased, and thus it is possible to further improve the no-load Q of the resonator.

Especially, when the via hole is formed at a position deviated toward the first end of the stripline conductor, the conductor loss, which may be caused by the stripline conductor, can be effectively reduced, while ensuring the electrical length of the stripline conductor.

When the first end of the stripline conductor is electrically connected to the ground electrode at the surface of the dielectric substrate, the first end of the stripline conductor is exposed from the dielectric substrate during the production process for the stacked type dielectric resonator. Therefore, it is easy to change the length of the stripline conductor, and thus it is easy to adjust the resonance frequency.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a perspective view illustrating an arrangement of a stacked type dielectric resonator according to an embodiment of the present invention;

FIG. 2 shows a longitudinal sectional view illustrating the arrangement of the stacked type dielectric resonator according to the embodiment of the present invention; and

FIG. 3 shows a longitudinal sectional view illustrating an arrangement of a stacked type dielectric resonator according to another embodiment.

### DESCRIPTION OF THE PREFERRED EMBODIMENTS

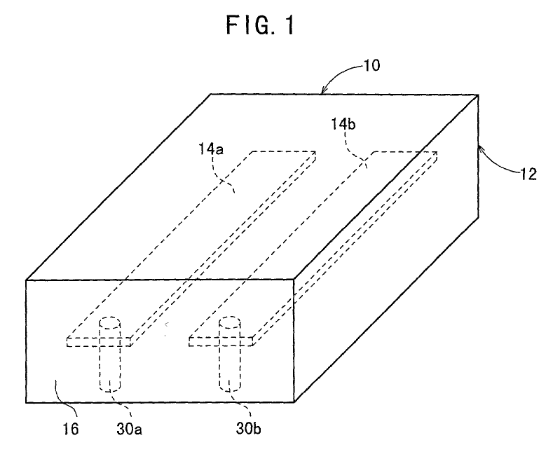

Illustrative embodiments of the stacked type dielectric resonator according to the present invention will be explained below with reference to FIGS. 1 to 3.

As shown in FIG. 1, a stacked type dielectric resonator according to an embodiment of the present invention comprises a plurality of (for example, two of) stripline conductors (¼ wavelength) 14a, 14b disposed in a dielectric substrate 12 constructed by stacking a plurality of dielectric layers.

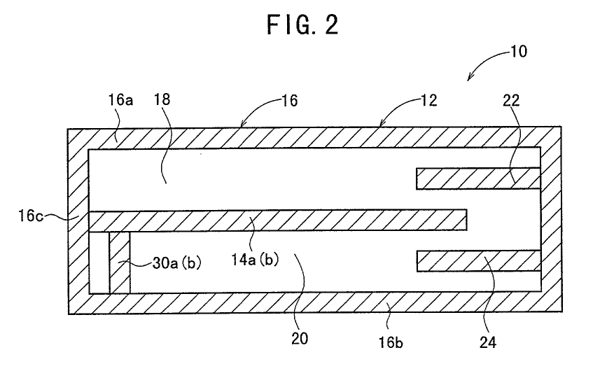

A ground electrode 16 is formed on the surface of the dielectric substrate 12. Specifically, for example, as shown in FIG. 2, the ground electrode 16 is continuously formed over a range including a part or all of the upper surface, a part or all of the lower surface, and a part or all of at least one side surface.

Accordingly, the following structure is obtained. That is, the upper surface ground electrode 16a is stacked over the stripline conductors 14a, 14b with a dielectric layer 18 interposed therebetween. The lower surface ground electrode 16b is stacked under the stripline conductors 14a, 14b with a dielectric layer 20 interposed therebetween.

In the embodiment of the present invention, as shown in FIG. 2, the arrangement is constructed such that respective first ends of the stripline conductors 14a, 14b are electrically connected and short-circuited with respect to the ground electrode 16c formed on the side surface of the dielectric substrate 12.

In this arrangement, for example, respective open ends of the stripline conductors 14a, 14b are capacitively coupled to the ground electrode 16 by the aid of inner layer ground electrodes 22, 24. Accordingly, it is possible to shorten the electrical length of each of the stripline conductors 14a, 14b.

That is, when a desired resonance frequency is obtained, the electrical length of the stripline conductor 14a, 14b can be shortened as compared with a structure in which the inner layer ground electrodes 22, 24 are not provided. Therefore, it is possible to miniaturize the stacked type dielectric resonator 10.

As shown in FIGS. 1 and 2, the stacked type dielectric resonator 10 according to the embodiment of the present invention is provided with via holes 30a, 30b which electrically connect the respective stripline conductors 14a, 14b, for example, to the lower surface ground electrode 16b respectively.

Accordingly, in the embodiment of the present invention, it is possible to increase the portion through which the high frequency current in the microwave band flows, owing to the formation of the via holes 30a, 30b. As a result, it is possible to effectively reduce, with the simple structure, the conductor loss which would be otherwise caused by the stripline conductors 14a, 14b. Further, it is possible to improve the no-load Q of the stacked type dielectric resonator 10.

Especially, when the via holes 30a, 30b are formed at positions deviated toward the first ends (short-circuited ends) of the stripline conductors 14a, 14b, then the conductor loss, which may be caused by the stripline conductors 14a, 14b, can be effectively reduced, while ensuring the electrical length of the stripline conductors 14a, 14b. Accordingly, this arrangement is preferably adopted.

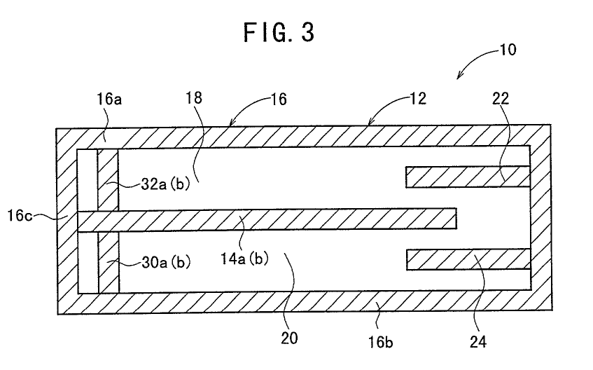

Alternatively, as shown in FIG. 3, it is also preferable to provide first via holes 30a, 30b which electrically connect the respective stripline conductors 14a, 14b and the lower surface ground electrode 16b, and second via holes 32a, 32b which electrically connect the respective stripline conductors 14a, 14b and the upper surface ground electrode 16a. In this arrangement, the portion, through which the high frequency current in the microwave band flows, is further increased. Thus, it is possible to further improve the no-load Q of the stacked type dielectric resonator 10.

Further, in the embodiment of the present invention, the first ends of the stripline conductors 14a, 14b are electrically connected to the ground electrode 16c at the side surface of the dielectric substrate 12. Therefore, the first ends of the stripline conductors 14a, 14b are exposed from the dielectric substrate 12, in the production process for the stacked type dielectric resonator 10 according to the embodiment of the present invention. In this case, it is easy to change the length of the stripline conductor 14a, 14b. Thus, it is easy to adjust the resonance frequency.

It is a matter of course that the stacked type dielectric resonator according to the present invention is not limited to the embodiments described above, which may be embodied in other various forms without deviating from the gist or essential characteristics of the present invention.

What is claimed is:

1. A stacked type dielectric resonator comprising:
a dielectric substrate including a plurality of dielectric layers stacked and integrated into one unit; and
a ground electrode and a stripline conductor stacked with each other with said dielectric layer interposed therebetween, wherein:
a first end of said stripline conductor is electrically connected to said ground electrode; and
said stripline conductor is provided with an additional member for increasing a portion through which a high frequency current in a microwave band flows.

2. The stacked type dielectric resonator according to claim 1, wherein said additional member is composed of a via hole for electrically connecting said stripline conductor and said ground electrode.

3. The stacked type dielectric resonator according to claim 2, wherein said via hole is formed at a position deviated toward said first end of said stripline conductor.

4. The stacked type dielectric resonator according to claim 1, wherein:
said ground electrode is stacked with said dielectric layers intervening therebetween so that said stripline conductor is interposed therebetween; and
said additional member is composed of via holes extending in both directions from said stripline conductor to portions of said ground electrode respectively.

5. The stacked type dielectric resonator according to claim 4, wherein said via hole is formed at a position deviated toward said first end of said stripline conductor.
